(19) United States
(12) Patent Application Publication
(10) Pub. No.: US 2012/0019428 A1
(43) Pub. Date: Jan. 26, 2012

(54) ANTENNA USING COMPOSITE RIGHT/LEFT-HANDED TRANSMISSION LINE AND METHOD FOR MANUFACTURING THE SAME

(75) Inventor: Jeong-Ho JU, Seoul (KR)

(73) Assignee: ELECTRONICS AND TELECOMMUNICATIONS RESEARCH INSTITUTE, Daejeon (KR)

(21) Appl. No.: 13/179,673

(22) Filed: Jul. 11, 2011

(30) Foreign Application Priority Data
Jul. 23, 2010 (KR) 10-2010-0071458

(51) Int. Cl. H01Q 1/50; H01P 11/00

(52) U.S. Cl. 343/860; 29/600

(57) ABSTRACT

An antenna includes: a radiation patch; a feed line having a first stage through which power is fed to the radiation patch, and a second stage connected to a feed terminal; a transformer disposed between the radiation patch and the first stage of the feed line and configured to match an impedance of the radiation patch with an impedance of the feed line; and a filter connected in series between the first stage and the second stage of the feed line and configured to filter resonances generated at frequency bands corresponding to integer multiples of a frequency applied to the radiation patch.

### CROSS-REFERENCE TO RELATED APPLICATIONS

The present application claims priority of Korean Patent Application No. 10-2010-0071458, filed on Jul. 23, 2010, which is incorporated herein by reference in its entirety.

### BACKGROUND OF THE INVENTION

1. Field of the Invention

Exemplary embodiments of the present invention relate to an antenna and a method for manufacturing the same; and, more particularly, to an antenna using a composite right/left-handed (CRLH) transmission line and a method for manufacturing the same.

2. Description of Related Art

With the recent rapid development of mobile communication and satellite communication, the role of wireless communications has become more important in the information society. Wireless communication technology, which originated from voice-oriented narrow-band communication, is rapidly moving toward wideband communication, such as internet, multimedia communication, and so on. Currently, the advent of new wireless services, such as the International Mobile Telecommunications (IMT)-2000 and the fourth generation mobile communication using ultra-high-rate mobile communication technology, has been expected. The technology for forming the base of such wireless communication is antenna technology, and the performance thereof influences the quality of communication. Hence, the importance of antenna technology has been gradually increasing.

In addition, as new services have been provided in recent years, cost loss occurs due to installation of new repeaters and base stations, and a lot of antennas are crowded within a densely populated area, causing destruction in environmental beautification. As one of approaches to solving such problems, much attention has been paid to a multi-band antenna technology which can converge an existing service and a new service through a single antenna. Therefore, there is a need for an antenna which can operate at various communication bands.

An antenna generates a resonance even at a frequency band corresponding to an integer multiple of a fundamental frequency, except for a desired fundamental frequency band. For example, the antenna generates a resonance at a harmonic band. When an additional element for suppressing a resonance generated at a harmonic band is not used, electromagnetic interference (EMI) is generated in other systems by the radiation at the harmonic band, causing malfunctions or affecting human body.

The additional use of the filter for suppressing a radiation at a harmonic band in order to prevent the electromagnetic interference increases an entire system size, which will cause problems in miniaturization and integration of the system and will cause increase in costs.

### SUMMARY OF THE INVENTION

An embodiment of the present invention is directed to an antenna using a CRLH transmission line and a method for manufacturing the same.

Another embodiment of the present invention is directed to an antenna, which can filter a specific frequency band by using a series-connected CRLH transmission line, without structural modification thereof, and a method for manufacturing the same.

Another embodiment of the present invention is directed to an antenna, which can filter multiple frequency bands by using a shunt-connected matching filter, without structural modification thereof, and a method for manufacturing the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an antenna includes: a radiation patch; a feed line having a first stage through which power is fed to the radiation patch, and a second stage connected to a feed terminal; a transformer disposed between the radiation patch and the first stage of the feed line and configured to match an impedance of the radiation patch with an impedance of the feed line; and a matched CRLH transmission line connected in series between the first stage and the second stage of the feed line and configured to pass only a necessary operating frequency applied to the radiation patch.

In accordance with another embodiment of the present invention, a method for manufacturing an antenna includes: forming a radiation patch; forming a feed line having a first stage connected to the radiation patch, and a second stage connected to a feed terminal; disposing a transformer between the radiation patch and the feed line, the transformer being configured to match an impedance of the radiation patch with an impedance of the feed line; and connecting a matched CRLH transmission line in series between the first stage and the second stage, the matched CRLH transmission line being configured to pass only an operating frequency applied to the radiation patch.

### BRIEF DESCRIPTION OF THE DRAWINGS

FIG. 1 is a schematic configuration diagram of a half-wavelength patch antenna in accordance with an embodiment of the present invention.

FIG. 2 is a graph showing S(1,1) parameter which is measured using a reflection coefficient at each frequency band.

FIG. 3 is a π-type equivalent circuit diagram of a CRLH transmission line structure in accordance with an embodiment of the present invention.

FIG. 4 is a T-type equivalent circuit diagram of a CRLH transmission line structure in accordance with an embodiment of the present invention.

FIG. 5 is a schematic configuration diagram of a half-wavelength antenna using a matching filter structure in accordance with an embodiment of the present invention.

FIG. 6 shows a simulation result of a half-wavelength antenna using a series-connected CRLH transmission line in accordance with the embodiment of the present invention.

FIG. 7 is a schematic configuration diagram of a half-wavelength antenna using shunt-connected CRLH transmission lines in accordance with an embodiment of the present invention.

FIG. 8 shows a simulation result of a half-wavelength antenna using shunt-connected CRLH transmission lines in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Embodiments of the present invention provide an antenna using a CRLH transmission line having a matching filter characteristic and a method for manufacturing the same. In addition, embodiments of the present invention provide an antenna, which can filter only a specific frequency band by using a series-connected CRLH transmission line, without structural modification thereof, and a method for manufacturing the same. Furthermore, embodiments of the present invention provide an antenna, which can filter multiple frequency bands by using a shunt-connected matching filter, without structural modification thereof, and a method for manufacturing the same.

Prior to describing an antenna in accordance with an embodiment of the present invention, an example of eliminating spurious resonance in a high-order mode of an antenna will be explained. First, a case using a photonic bandgap (PBG) structure will be described. The PBG structure has a characteristic that blocks an electromagnetic wave having a specific frequency. Thus, by designing an antenna using the PBG structure, spurious resonance in a high-order mode of an antenna can be eliminated.

A method for manufacturing a PBG structure will be exemplarily described. The PBG structure may be manufactured in a periodic grid structure which is made by drilling holes in a dielectric. In addition, the PBG structure may be manufactured by forming vias in a rectangular radiation patch and connecting them to a ground plane. Furthermore, the PBG structure may be manufactured by printing periodic metal patterns on a radiation patch, or by periodically etching circular slots in a ground plane. However, the above-mentioned PBG structure is inserted in the middle of the dielectric or is periodically formed by a ground etching, the integration with a transmission line is not easy. Moreover, spurious radiation may be caused through an etched surface, adversely affecting an entire system.

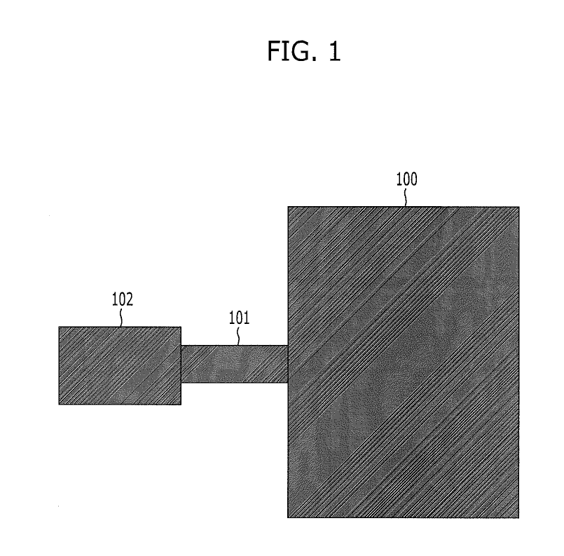

As another method, spurious resonance in a high-order mode of an antenna can be eliminated by designing an antenna using a defected ground structure (DGS). The DGS structure rejects a signal at a specific band, and a signal transfer rate becomes slow. In addition, the DGS structure may be easily manufactured by forming a simple connection structure on a ground plane of a substrate by an etching and forming a general transmission line on the substrate. However, as in the case of the PBG structure, the DGS structure is manufactured by an etching. Thus, spurious radiation may be caused through an etched surface, adversely affecting an entire system. A structure of a half-wavelength patch antenna in accordance with an embodiment of the present invention will be described below in more detail with reference to FIG. 1.

FIG. 1 is a schematic configuration diagram of a half-wavelength patch antenna in accordance with an embodiment of the present invention.

Referring to FIG. 1, the half-wavelength patch antenna includes a radiation patch 100, a transformer 101, and a feed line 102. The half-wavelength patch antenna is a planar antenna in which a dielectric (not shown) is formed on a ground patch (not shown) and the rectangular radiation patch 100 is attached to the top surface of the dielectric. The size of the radiation patch 100 is w×h, and the width w of the radiation patch 100 influences the impedance thereof. In addition, the length h of the radiation patch 100 influences a resonant frequency of an antenna.

Therefore, when the radiation patch 100 is designed to be narrow, the radiation efficiency thereof is lowered. On the other hand, when the radiation patch 100 is designed to be wide, the radiation efficiency thereof is increased, but a high-order mode occurs to cause distortion of a field. The width and length of the radiation patch 100 are varied depending on the radiation efficiency upon design of the antenna. Since this is designed differently according to the manufacturing purpose of the antenna, the invention is not limited to the size of the radiation patch 100.

Power may be fed to the radiation patch 100 through the feed line 102. At this time, when the impedance of the feed line 102 is different from the impedance of the radiation patch 100, reflection loss is caused by mismatch between the feed line 102 and the radiation patch 100. That is, the reflection loss occurs at a portion in which the radiation patch 100 and the feed line 102 are coupled together. For this reason, the transformer 101 is installed between the radiation patch 100 and the feed line 102 to match the impedances thereof. The transformer 101 is implemented with ¼ wavelength of a signal applied to the radiation patch 100.

Exemplary impedance matching methods will be described below. First, a microstrip line may be installed to feed power to the radiation patch 100. In the power feeding method using the microstrip line, the characteristic and input impedance of the antenna are varied depending on a power feeding position. Hence, the matching between the feed line 102 and the radiation patch 100 is important.

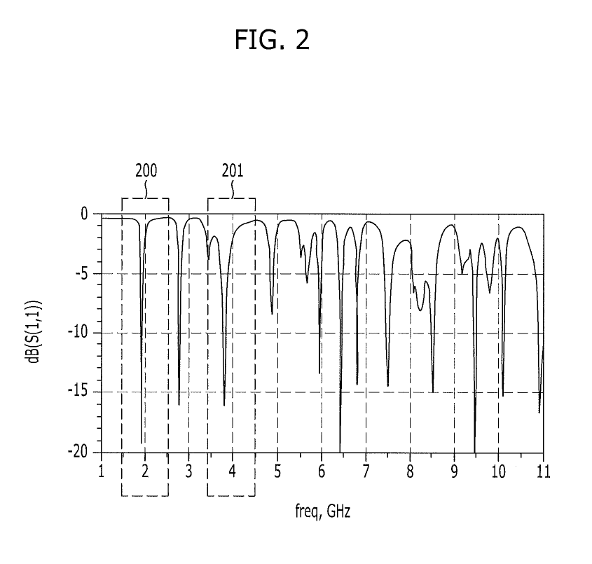

Second, a probe may be installed to feed power to the radiation patch 100. The feeding method using the probe does not require an additional matching circuit because it can find the most suitable matching position and feed power to the found position. In a case in which the feed line 102 having an impedance of 50 ohms is installed in the radiation patch 100 and power is fed to the radiation patch 100, its simulation result will be described with reference to FIG. 2. FIG. 2 is a graph showing S(1,1) parameter which is measured using a reflection coefficient at each frequency band.

FIG. 2 is a simulation result of a half-wavelength patch antenna. Specifically, in a case in which a signal power inputted from the feed line 102 to the radiation patch 100 at a frequency of 1.9 GHz (200) is totally reflected, a reflection coefficient is exemplarily illustrated in FIG. 2.

In FIG. 2, an X-axis represents a frequency, and a Y-axis represents a reflection coefficient when the feed line 102 having an impedance of 50 ohms is installed in the radiation patch 100. As a simulation result, a resonant frequency of a basic mode is determined at a fundamental frequency band, for example, 1.9 GHz (200).

However, it can be seen that spurious resonance is generated by a high-order mode even at a harmonic band (e.g., 3.8 GHz (201), 5.7 GHz (202), etc.) corresponding to an integer multiple of a fundamental frequency, except for a fundamental frequency band. In this case, electromagnetic interference may be generated in other systems by the radiation at the harmonic band, causing malfunctions or affecting human body.

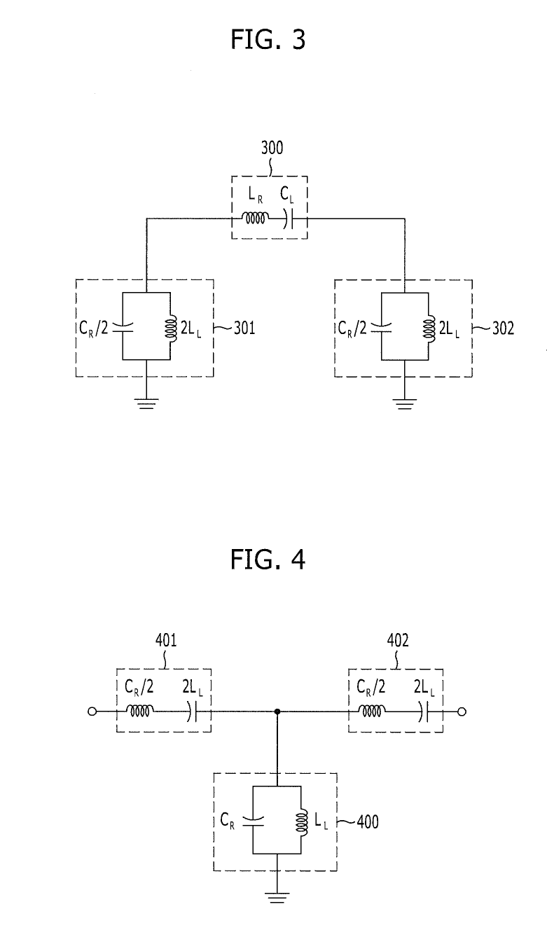

A π-type equivalent circuit and T-type equivalent circuit of a CRLH transmission line structure for eliminating spurious resonance, except for a basic mode resonance, in accordance with an embodiment of the present invention, will be described in more detail with reference to FIGS. 3 and 4.

FIG. 3 is a π-type equivalent circuit diagram of a CRLH transmission line structure for eliminating spurious resonance, except for a basic mode resonance, in accordance with an embodiment of the present invention. FIG. 4 is a T-type equivalent circuit diagram of a CRLH transmission line structure for eliminating spurious resonance, except for a basic mode resonance, in accordance with an embodiment of the present invention.

Prior to the description of FIGS. 3 and 4, a CRLH transmission line structure will be described below. The CRLH transmission line structure is composite of right-handed (RH) components and left-handed components. A series inductance L_{R} and a shunt capacitance C_{L} are RH components which cause a phase delay, and a series capacitance L_{L} and a shunt inductance C_{L} are RH components which cause a phase lead.

On the microstrip line, the RH components comply with an RH propagation phenomenon, which is usually observed in the natural world. This is a case in which wave energy and phase shift direction are in-phase. This includes a low-pass characteristic of a band-pass filter.

A combination of the inductance and the capacitance generates a resonance phenomenon. Due to the generated resonance phenomenon, a desired frequency band signal is passed or rejected. The combination of the inductance and the capacitance is widely used to pass a necessary signal and eliminate an unnecessary signal in a relative low frequency signal.

That is, when meeting a balanced condition to equally set the resonant frequencies of the RH components and the resonant frequencies of the LH components to the center of a UHF band or an ISM band, an infinite wavelength phenomenon (zeroth order resonance: ZOR) occurs. Specifically, a frequency exists, but a phase and a propagation constant become zero. Thus, a resonance irrelative to a wavelength occurs. As such, when the propagation constant is zero, the wavelength becomes equal to infinite. An in-phase electromagnetic field can be formed on a structure, without regard to a physical length of a transmission line. Hence, miniaturization and performance improvement of parts can be achieved.

Referring to FIG. 3, an LH component can be implemented by periodically cascading a CRLH transmission line unit cell. In the unit cell, a series inductance and a series capacitance 300 are disposed, and shunt capacitances and shunt inductances 301 and 302 are divided proportionally and disposed at both wings of the π-type circuit. Such a π-type unit cell can be periodically connected.

Referring to FIG. 4, an LH component can be implemented by periodically cascading a CRLH transmission line unit cell. In the unit cell, a shunt inductance and a shunt capacitance 400 are disposed, and series capacitances and series inductances 401 and 402 are divided proportionally and disposed at both wings of the T-type circuit. Such a T-type unit cell can be periodically connected.

In FIGS. 3 and 4, a cutoff frequency F_{cr} is determined by the RH characteristic and a pass band is formed, and a cutoff frequency F_{cl} is determined by the LH characteristic and a pass band is determined. In addition, a series resonance Fₛₑ can be generated by the series inductance L_{R} and the shunt inductance C_{L}, and a shunt resonance Fₛₕ can be generated by the shunt capacitance C_{R} and the series capacitance L_{L}.

A stop band is formed by the cutoff frequencies of the RH and the LH. The unbalanced structure forms a band gap after the cutoff frequency and again forms a band pass characteristic after the band gap. Thus, the stop band can be widened by spacing further apart from the cutoff frequency. Therefore, in the unbalanced structure, Fₛₑ and Fₛₕ are set to infinite.

In the unbalanced structure, the equivalent circuit values are changed according to the relative magnitudes of the resonant frequencies of the series resonator and the shunt resonator. Table 1 below shows the equivalent circuit values of the π-type model of FIG. 3, and Table 2 below shows the equivalent circuit values of the T-type model of FIG. 4.

TABLE 1

| | L_{L} (nH) | L_{R} (nH) | C_{L} (pF) | C_{R} (pF) |
|---|---|---|---|---|
| Balanced (Fₛₑ = Fₛₕ) | 0.53 | 31.83 | 0.21 | 12.73 |
| Unbalanced (Fₛₑ(∞) > Fₛₕ) | 0.53 | 0 | 1.66 | 9.83 |
| Unbalanced (Fₛₑ < Fₛₕ₍∞)) | 2.34 | 13.87 | 0.377 | 0 |

TABLE 2

| | L_{L} (nH) | L_{R} (nH) | C_{L} (pF) | C_{R} (pF) |
|---|---|---|---|---|
| Balanced (Fₛₑ = Fₛₕ) | 0.53 | 31.83 | 0.21 | 12.7 |
| Unbalanced (Fₛₑ(∞) > Fₛₕ) | 0.94 | 0 | 0.93 | 5.55 |
| Unbalanced (Fₛₑ < Fₛₕ₍∞)) | 4.15 | 24.6 | 0.21 | 0 |

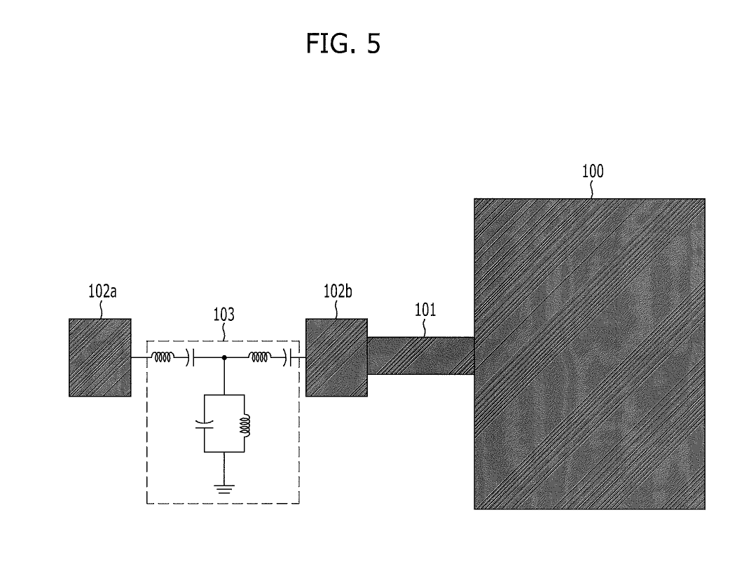

In Tables 1 and 2 above, L_{L} is a series capacitance, L_{R} is a series inductance, C_{L} is a shunt inductance, and C_{R} is a shunt capacitance. Each of the equivalent circuit values was designed to have a Bloch impedance of 50 ohms at 1.9 GHz. In the balanced structure, F_{cl} and F_{cr} were designed to have 1.7 GHz and 2.2 GHz, respectively. In the unbalanced structure, F_{cl} was designed to have 1.7 GHz, and Fₛₑ and Fₛₕ were 2.2 GHz. Hereinafter, a structure of a half-wavelength patch antenna using a CRLH transmission line in accordance with an embodiment of the present invention will be described with reference to FIG. 5.

FIG. 5 is a schematic configuration diagram of a half-wavelength patch antenna using a cascaded matching filter structure in accordance with an embodiment of the present invention.

Referring to FIG. 5, the half-wavelength patch antenna includes a radiation patch 100, a transformer 101, a feed line including a first stage 102a and a second stage 102b, and a CRLH transmission line 103. The half-wavelength patch antenna is a planar antenna in which a dielectric (not shown) is formed on a ground patch (not shown) and the radiation patch 100 is attached to the top surface of the dielectric. The radiation patch 100 may be formed in various shapes, for example, a rectangular shape, a circular shape, an oval shape, a rectangular shape, or a ring shape.

The first stage 102a feeds power to the radiation patch 100, and the second stage 102b is connected to a feed terminal. The transformer 101 is disposed between the radiation patch 100 and the first stage 102a of the feed line and matches the impedance of the radiation patch 100 with the impedance of the feed line 102a and 102b. The CRLH transmission line 103 is connected in series between the first stage 102a and the second stage 102b of the feed line, and filters a resonance generated at a frequency band corresponding to an integral multiple of a frequency applied to the radiation patch 100.

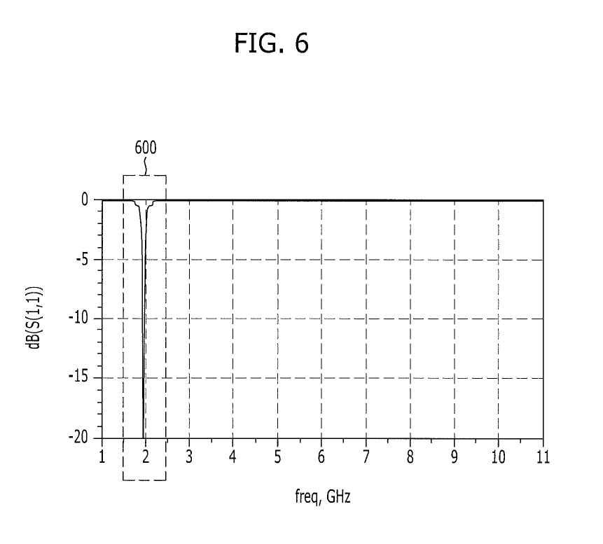

For example, the CRLH transmission line 103 is designed to have 50 ohms at an operating frequency, for example, 1.9 GHz. Thus, the CRLH transmission line 103 may be designed to filter only one operating frequency. In addition, since the impedance of the CRLH transmission line 103 is equal to the impedance of the feed line 102a and 102b, the CRLH transmission line 103 may be inserted in the middle of the feed line 102a and 102b. A simulation result of the half-wavelength antenna using the CRLH transmission line structure in accordance with the embodiment of the present invention will be described below with reference to FIG. 6.

FIG. 6 shows a simulation result of the half-wavelength antenna using the CRLH transmission line in accordance with the embodiment of the present invention. Specifically, FIG. 6 is a graph showing S(1,1) parameter which was measured using a reflection coefficient at each frequency band.

In FIG. 6, an X-axis represents a frequency, and a Y-axis represents a reflection coefficient in a case in which power is fed in such a situation that the feed line 102a and 102b having an impedance of 50 ohms is installed in the radiation patch 100 and the CRLH transmission line 103 having an impedance of 50 ohms is inserted in the middle of the feed line 102a and 102b. It can be seen from the simulation result that, among a resonant frequency by a basic mode in a fundamental frequency band and spurious resonances by high-order modes in harmonic bands corresponding to integer multiples of the fundamental frequency except for the fundamental frequency band, a reflection loss was good only at an operating frequency band, for example, 1.9 GHz (600), and spurious resonances occurring in the harmonic bands corresponding to the integer multiples of the fundamental frequency except for the operating frequency band were disappeared.

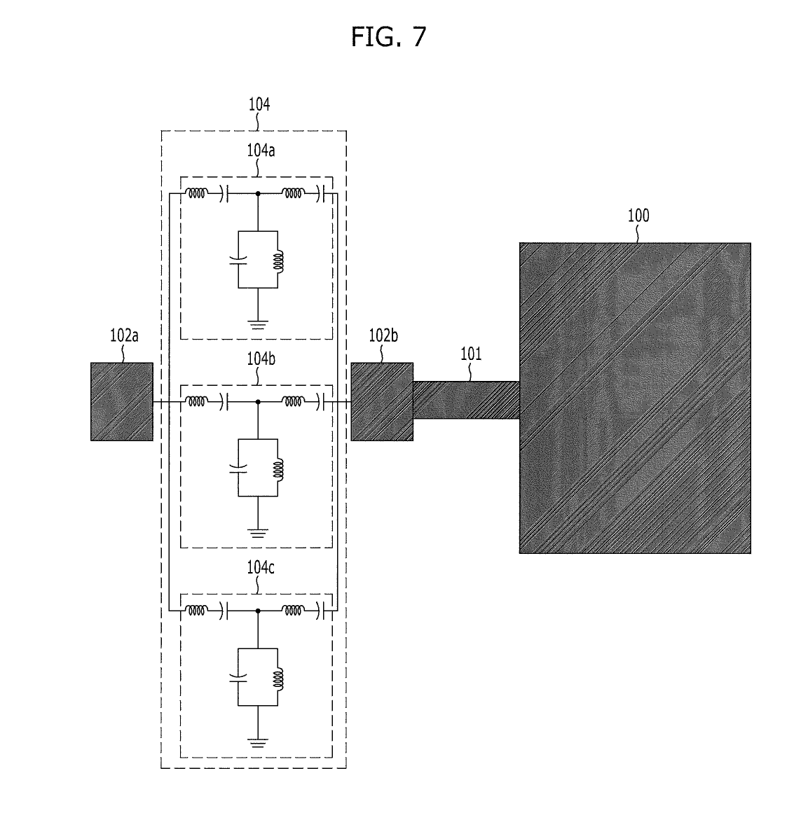

That is, the CRLH transmission line 103 was designed to have an impedance of 50 ohms and operate only at 1.9 GHz. By inserting the designed CRLH transmission line 103 in the middle of the feed line 102a and 102b, the reflection loss was good only at 1.9 GHz (700) and the spurious resonances were disappeared. The half-wavelength antenna having the CRLH transmission line 103 connected thereto can easily eliminate spurious resonances, without modification in the design structure of the existing half-wavelength antenna. A structure of a half-wavelength antenna using the CRLH transmission lines connected in shunt with one another in accordance with an embodiment of the present invention will be described in more detail with reference to FIG. 7.

FIG. 7 is a schematic configuration diagram of a half-wavelength antenna using shunt-connected CRLH transmission lines in accordance with an embodiment of the present invention. Specifically, FIG. 7 is an exemplary view illustrating a structure of a half-wavelength antenna having three CRLH transmission lines connected in shunt with one another. The number of the CRLH transmission lines connected in shunt with one another may be changed depending on a frequency band to be filtered.

Referring to FIG. 7, the half-wavelength patch antenna includes a radiation patch 100, a transformer 101, a feed line including a first stage 102a and a second stage 102b, and CRLH transmission lines 104a, 104b and 104c. The half-wavelength patch antenna is a planar antenna in which a dielectric (not shown) is formed on a ground patch (not shown) and the radiation patch 100 is attached to the top surface of the dielectric. The radiation patch 100 may be formed in various shapes, for example, a rectangular shape, a circular shape, an oval shape, a rectangular shape, or a ring shape.

The first stage 102a feeds power to the radiation patch 100, and the second stage 102b is connected to a feed terminal. The transformer 101 is disposed between the radiation patch 100 and the first stage 102a of the feed line and matches the impedance of the radiation patch 100 and the impedance of the feed line 102a and 102b. The CRLH transmission lines 104a, 104b and 104c are connected in shunt with one another, and the shunt-connected CRLH transmission lines 104a, 104b and 104c are connected in series between the first stage 102a and the second stage 102b of the feed line. In addition, the CRLH transmission lines 104a, 104b and 104c filter resonances generated at different frequency bands.

For example, the CRLH transmission lines 104a, 104b and 104c are connected in shunt with one another and may be designed to have 50 ohms and operate at different operating frequencies, for example, 1.9 GHz, 2.7 GHz, and 3.7 GHz. That is, the CRLH transmission lines 104a, 104b and 104c may be designed to filter only the frequencies of 1.9 GHz, 2.7 GHz, and 3.7 GHz.

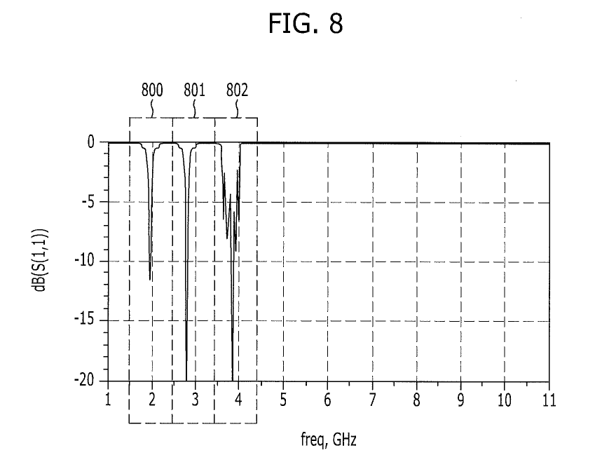

Since the impedance of the shunt-connected CRLH transmission lines 104a, 104b and 104c is equal to the impedance of the feed line 102a and 102b, the CRLH transmission lines 104a, 104b and 104c may be inserted between the first stage 102a and the second stage 102b. Thus, it is possible to easily eliminate spurious resonances by filtering only the multiple frequency bands, without modification in the structure of the half-wavelength patch antenna. A simulation result of the half-wavelength antenna using the CRLH transmission line structure in accordance with the embodiment of the present invention will be described below with reference to FIG. 8.

FIG. 8 shows a simulation result of the half-wavelength antenna using the CRLH transmission line in accordance with the embodiment of the present invention. Specifically, FIG. 8 is a graph showing S(1,1) parameter which was measured using a reflection coefficient at each frequency band.

In FIG. 8, an X-axis represents a frequency, and a Y-axis represents a reflection coefficient in a case in which power is fed in such a situation that the feed line 102a and 102b having an impedance of 50 ohms is installed in the radiation patch 100 and the CRLH transmission lines 104a, 104b and 104c having an impedance of 50 ohms is connected in a shunt structure in the middle of the first and second stages 102a and 102b.

It can be seen from the simulation result that, among a resonant frequency by a basic mode in a fundamental frequency band and spurious resonances by high-order modes in harmonic bands corresponding to integer multiples of the fundamental frequency except for the fundamental frequency band, a reflection loss was good only at the operating frequency bands, for example, 1.9 GHz (800), 2.7 GHz (801), 3.7 GHz (802), and spurious resonances occurring in the harmonic bands corresponding to the integer multiples of the fundamental frequency except for the operating frequency band were disappeared.

That is, the CRLH transmission lines 104a, 104b and 104c were designed to have an impedance of 50 ohms and operate only at 1.9 GHz, 2.7 GHz, and 3.7 GHz. By inserting the designed CRLH transmission lines 104a, 104b and 104c in the middle of the feed line 103, the filtering can be achieved at multi-bands.

In accordance with the exemplary embodiments of the present invention, spurious harmonic waves can be eliminated by filtering only a specific frequency band by using the matched CRLH transmission line having filtering characteristics, without structural modification of antennas. In addition, spurious harmonic waves can be eliminated by filtering only multiple frequency bands by using the shunt structure of the matched CRLH transmission lines having filtering characteristics, without structural modification of antennas. Sources which may operate as noise in an adjacent channel can be eliminated by removing radiation power generated by spurious resonance.

While the present invention has been described with respect to the specific embodiments, it will be apparent to those skilled in the art that various changes and modifications may be made without departing from the spirit and scope of the invention as defined in the following claims.

What is claimed is:

1. An antenna comprising:
a radiation patch;
a feed line having a first stage through which power is fed to the radiation patch, and a second stage connected to a feed terminal;
a transformer disposed between the radiation patch and the first stage of the feed line and configured to match an impedance of the radiation patch with an impedance of the feed line; and
a filter connected in series between the first stage and the second stage of the feed line and configured to filter resonances generated at frequency bands corresponding to integer multiples of a frequency applied to the radiation patch.

2. The antenna of claim 1, wherein the filter is provided in plurality in correspondence to the number of the frequency bands, and the plurality of filters are connected in shunt to one another.

3. The antenna of claim 1, wherein the plurality of filters filter resonances generated at different frequency bands.

4. The antenna of claim 1, wherein the filter is formed with a T-type equivalent circuit.

5. The antenna of claim 1, wherein the T-type equivalent circuit comprises:
a first inductance and a first capacitance connected in series between the first stage and the second stage;
a second inductance and a second capacitance connected in series between the first stage and the second stage; and
a third inductance and a third capacitance connected in shunt between the first capacitance and the second inductance.

6. The antenna of claim 1, wherein the filter is formed with a π-type equivalent circuit.

7. The antenna of claim 6, wherein the π-type equivalent circuit comprises:
a first inductance and a first capacitance connected in series between the first stage and the second stage;
a second inductance and a second capacitance connected in shunt at a point where the first stage is contacted with the first inductance and the first capacitance; and
a third inductance and a third capacitance connected in shunt at a point where the second stage is contacted with the first inductance and the first capacitance.

8. The antenna of claim 1, wherein the radiation patch is disposed on a dielectric which is formed on a ground patch.

9. The antenna of claim 1, wherein the transformer is implemented with ¼ wavelength of a signal applied to the radiation patch.

10. The antenna of claim 1, wherein an impedance of the filter is equal to an impedance of the feed line.

11. A method for manufacturing an antenna, the method comprising:
forming a dielectric on a ground patch;
disposing a radiation patch having a predefined shape on the dielectric;
forming a feed line having a first stage through which power is fed to the radiation patch, and a second stage connected to a feed terminal;
disposing a transformer between the radiation patch and the feed line, the transformer being configured to match an impedance of the radiation patch with an impedance of the feed line; and
connecting a filter in series between the first stage and the second stage, the filter being configured to filter resonances generated at frequency bands corresponding to integer multiples of a frequency applied to the radiation patch.

12. The method of claim 11, wherein the filter is provided in plurality in correspondence to the number of the frequency bands, and the plurality of filters are connected in shunt to one another.

13. The method of claim 11, wherein the plurality of filters filter resonances generated at different frequency bands.

14. The method of claim 11, wherein the filter is formed with a T-type equivalent circuit.

15. The method of claim 14, wherein the T-type equivalent circuit is manufactured by disposing a shunt capacitance and a shunt inductance, proportionally dividing a series inductance and a series capacitance, and disposing the proportionally divided series inductance and series capacitance on the T-type equivalent circuit.

16. The method of claim 11, wherein the filter is formed with a π-type equivalent circuit.

17. The method of claim 16, wherein the π-type equivalent circuit is manufactured by disposing a series inductance and a series capacitance, proportionally dividing a shunt capacitance and a shunt inductance, and disposing the proportionally divided shunt capacitance and shunt inductance on the π-type equivalent circuit.

18. The method of claim 11, wherein the transformer is implemented with ¼ wavelength of a signal applied to the radiation patch.

19. The method of claim 11, wherein an impedance of the filter is equal to an impedance of the feed line.
